(19) United States
(12) Patent Application Publication
(10) Pub. No.: US 2004/0129640 A9
(43) Pub. Date: Jul. 8, 2004

(54) Materials comprising polymers or oligomers of saccharides chemically bonded to a support useful for chromatography and electrophoresis applications

(75) Inventors: Siu Choon Ng, Singapore (SG); Chi Bun Ching, Singapore (SG); Li Feng Zhang, Singapore (SG); Lei Chen, Singapore (SG)

Correspondence Address: KLARQUIST SPARKMAN, LLP, One World Trade Center, Suite 1600, 121 S. W. Salmon Street, Portland, OR, 97204, US

(73) Assignee: National University of Singapore

(21) Appl. No.: 10/054,162

(22) Filed: Jan. 18, 2002

(51) Int. Cl. B01D 15/08

(52) U.S. Cl. 210/656

(57) ABSTRACT

A novel conjugate comprising a support material and an oligomer or polymer of a saccharide, in which the oligomer or polymer is linked to the support material via one or more ether, carbamate, ester, or imino linkages between the saccharide and the support material, and in which the saccharide is fully functionalized, provides a valuable stationary phase for chromatography. It is particularly valuable as a chiral stationary phase in enantiomeric separations and enantiomeric analysis.

### FIELD OF THE INVENTION

The present invention relates to the development of novel materials that can be used in a process such as chromatography. The invention further relates to processes for the production of these materials and their use in separating compounds and especially resolving enantiomeric mixtures.

### BACKGROUND OF THE INVENTION

Generic applicability of cyclodextrins in chromatographic separation and purification processes is described at length in reviews by W. L. Hinze, Cyclodextrins in Chromatography, 1982, 159-227. Y. Kawaguchi, et al., Anal. Chem., 1983, 55, 1852; D. W. Armstrong, et al., Anal. Chem., 1985, 57, 234 and S. Li, et al., Chem. Rev., 1992, 92, 1457. Chromatographic separation on chiral stationary phases (CSP) is also the most convenient analytical method for the determination of enantiomeric purity (see for example S. G. Allenmark, Chromatographic Enantioseparations: Methods and Applications, 2^{nd} ed., Prentice Hall, N.J., 1991).

In recent years, research efforts were made in bonding cyclodextrins to solid matrices, such as silica gel, via amino or amido linkages. However, these bonds are inherently unstable to hydrolysis, thus placing severe limitations on use of these materials in aqueous media. Alternative approaches for immobilizing cyclodextrin using hydrolytically more stable ether linkages (U.S. Pat. No. 4,539,399) or carbamic acid moieties (U.S. Pat. No. 5,104,547) were also investigated.

Pristine cyclodextrin which has been immobilized on a solid support has displayed low enantioselectivity as a chiral stationary phase in liquid chromatography. It has been reported, however, that chiral stationary phases derived from immobilized cyclodextrin whose free hydroxyl groups have been functionalized have shown definite enantioselectivity for a variety of compounds. For example, the enantioselectivity of the materials was generally improved by increasing the degree of derivatisation of the —OH groups on cyclodextrin with carbamate groups, and by increasing the surface concentration of cyclodextrin immobilized on the support materials (D. W. Armstrong et al., Anal. Chem., 1990, 62, 1610; T. Hargitai et al., J. Chromatogr., 1993, 628, 11; T. Hargitai, et al., J. Liq. Chromatogr., 1993, 16(4), 843). In order to maximize the extent of cyclodextrin derivatisation, large molar excesses of derivatising reagents under vigorous conditions were often used. However, the derivatisation processes invariably involved the prior immobilisation of underivatised cyclodextrin on the support material followed by derivatisation procedures involving solid-liquid phases. This may result in partial derivatisation of the hydroxyl groups of the cyclodextrin and also in large, sterically encumbered cyclodextrins having a low extent of derivatisation. These methods did not give good reproducibility or uniformity of product, with the consequence that separation of enantiomers varied from batch to batch of the obtained CD-based CSP.

In U.S. Pat. No. 6,017,458, a procedure of immobilizing perfunctionalized cyclodextrin onto the surface of a support of aminised silica gel to form urea linkages is described. The immobilized cyclodextrin is then used as a chiral stationary phase to resolve the enantiomers of various racemic compounds. The support described in U.S. Pat. No. 6,017,458 may, however, have strong interactions with samples of racemic acids, which may consequently lead to poor resolution of the enantiomers of these acids.

### SUMMARY OF THE INVENTION

In one aspect, the present invention provides a conjugate comprising a support material and an oligomer or polymer of a saccharide, wherein the oligomer or polymer is linked to said support material via one or more ether, carbamate, ester, or imino linkages between the saccharide and the support material, and wherein the saccharide is fully functionalized.

In a further aspect, the present invention provides a process for preparing a conjugate of a support material and an oligomer or polymer of a saccharide, the process comprising reacting the support material with an oligomer or polymer of a saccharide reactant bearing one or more pendant electrophilic moieties or nucleophilic moieties, wherein the electrophilic moieties or nucleophilic moieties are linked to said saccharide via one or more ether, carbamate, ester, or imino linkages, and the support material has groups that are reactive with said electrophilic moieties or said nucleophilic moieties, and wherein the saccharide reactant is fully functionalized.

In another aspect, the present invention provides an oligomer or polymer of a saccharide bearing one or more pendant electrophilic moieties or nucleophilic moieties, wherein the electrophilic moieties or nucleophilic moieties are linked to said saccharide via one or more ether, carbamate, ester, or imino linkages, and wherein the saccharide is fully functionalized.

In a further aspect, the present invention provides a chromatographic process comprising separating compounds using, as a stationary phase, in, for example, an enantiomeric separation or enantiomeric analysis, a conjugate which comprises a support material linked to oligomers or polymers of a saccharide, preferably a cyclodextrin, which linking is via one or more ether, carbamate, ester, or imino linkages between the saccharide and the support material, and wherein the saccharide is fully functionalized.

Particularly but not exclusively, conjugates of the invention are useful in high performance liquid chromatography (HPLC), liquid chromatography (LC), gas chromatography (GC), capillary electro-chromatography (CEC), super-critical liquid chromatography and counter-current chromatography.

### BRIEF DESCRIPTION OF THE DRAWINGS

FIGS. 1-2 show, by way of example, embodiments of a process of the invention in which β-cyclodextrin is immobilized onto the surface of a support material.

FIG. 3 shows a chromatogram of labetalol separated by HPLC using a pernaphthylcarbamoylated β-cyclodextrin (PNACD)immobilized silica column.

### DESCRIPTION OF PREFERRED EMBODIMENTS

The oligomer or polymer of a saccharide can be straight-chained, or cyclic. Examples of saccharides include glucose, fructose, mannose, galactose, ribose, arabinose, xylose, lyxose, erythrose and threose, of which glucose is preferred.

Most preferably a cyclic oligomer is used, especially α, β or γ cyclodextrin composed of six, seven or eight glucose moieties, respectively. Straight-chained oligomers and polymers can be used, however, and mention is made of cellulose, amylose and pullulan as materials that can serve as the saccharide-containing oligomer or polymer. They can be used in the form of their esters, for example cellulose acetate, provided that there are sufficient free hydroxyl groups to participate in the reaction to form the conjugate of the invention, as described below.

The subsequent description is given with respect to glucose, and particularly with respect to cyclodextrins, but it should be understood that use of oligomers and polymers of saccharides other than glucose, and glucose other than in the form of cyclodextrins, are also within the scope of the invention.

In the conjugate of the present invention, the support material and the oligomer or polymer of glucose are preferably linked by one or more linkers which comprise a group of the formula (I):

ACH₂CH₂(CH₂)ₙ₋₁CH₂B— (I)

between a glucose unit of the oliogomer or polymer and the support material, the group A being attached to the support material, and the group B being attached to the glucose unit;

wherein A=—S, —S(O), —S(O)₂ or

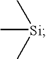

B is O, NH, a carbamate group, or an ester group, and

n is a number in the range of from 1 to 20.

In a preferred embodiment, the present invention provides a conjugate of silica gel and β-cyclodextrin, wherein the silica gel and the β-cyclodextrin are linked by one or more linkers which comprise a group of the formula (I):

ACH₂CH₂(CH₂)ₙ₋₁CH₂B— (I)

between a glucose unit of β-cyclodextrin and the support material, the group A being attached to the support material, and the group B being attached to the glucose unit;

wherein A=—S, —S(O), —S(O)₂ or

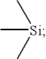

B is O, NH, a carbamate group, or an ester group; and

n is a number in the range of from 1 to 20; and

wherein the glucose moieties are fully functionalized.

In forming a conjugate of the present invention, there is used an oligomer or polymer of glucose bearing a pendant silyl moiety having at least one readily hydrolysable group attached to the silicon atom. The conjugate is preferably prepared by reacting an oligomer or polymer of glucose bearing a pendant alkenyl moiety with a hydrosilylating agent. The pendant alkenyl moiety is preferably a group of formula (II):

CH₂═CH(CH₂)ₙ— (II)

where n is a number in the range of from 1 to 20. One or more methylene groups in the group of formula (II) can be replaced by an oxygen atom, an NH group, an NR′ group, a sulfur atom or a SiR′₂ group, where R′ is an alkyl group, an aryl group, or an arylalkyl group.

The oligomer or polymer of glucose bearing a pendant alkenyl moiety can be made by reacting an oligomer or polymer of glucose with a reactant bearing an alkenyl moiety and a leaving group. These reactions are preferably conducted using a suitable base, such as NaH, LiH, NaOMe, NaNH₂, or KOₜBu.

Preferably, only hydroxyl groups at the 6-position of the glucose moieties are alkylated with the reactant bearing an alkenyl moiety. Alkylation of hydroxyl groups at the 2- and 3-positions, in addition to the 6-position, with the reactant bearing an alkenyl moiety, is also, however, within the scope of the invention. Alkylation of the hydroxyl groups at the 2-, 3- and 6-positions may be partial or complete.

As primary hydroxyl groups react more readily than secondary hydroxyl groups, it is possible to ensure that reaction occurs more readily at the primary hydroxyl groups by selection of the appropriate molar ratios of alkylating agent to hydroxyl groups. For example, only some of the primary hydroxyl groups of cyclodextrin are alkylated with bromo-1-pentene, in the presence of NaH, when a molar ratio of alkylating agent to β-cyclodextrin of 1.5 is used. The number of primary hydroxyl groups of the glucose moieties of β-cyclodextrin that are alkylated with the reactant bearing an alkenyl moiety is preferably five, more preferably six, and most preferably seven.

The reactant bearing an alkenyl moiety and a leaving group is preferably a straight-chained α-olefin with a leaving group attached to the ω-carbon atom, such as, for example, a compound of formula (III):

CH₂═CH(CH₂)ₙX (III)

wherein n is a number in the range of from 1 to 20, and X is a leaving group, for example, a halide such as iodide, bromide or chloride, a mesylate group, a tosylate group or a triflate group; or X is a —NCO group, or a —COR¹ group, where R¹ is a halide or a —OR² group, where R² is an alkyl group, an aryl group, or an arylalkyl group. The number of carbon atoms in the reactant is not critical, but is suitably in the range of from 3 to 20, and 6-bromohex-1-ene is mentioned as an example. One or more methylene groups in the reactant can be replaced by an oxygen atom, an NH group, an NR′ group, a sulfur atom or a SiR′₂ group, where R′ is defined above.

As an example, reaction of a reactant of formula (III), where X is Br, with primary hydroxyl groups of glucose units of β-cyclodextrin in the presence of a base will result in formation of a β-cyclodextrin having alkenyl moieties attached to the carbon atoms at the 6-position of the glucose units by ether linkages.

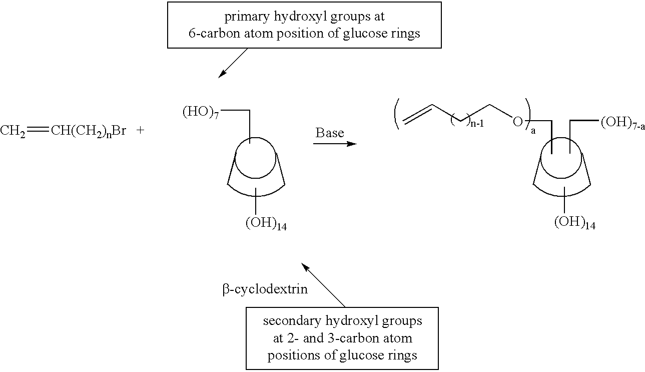

Similarly, reaction of a reactant of formula (III), where X is an —NCO group or a —COR¹ group, with the primary hydroxyl groups of β-cyclodextrin, will result in a β-cyclodextrin having alkenyl moieties attached to the carbon atoms at the 6-position of the glucose units by carbamate and ester linkages, respectively.

In an alternative embodiment, the oligomer or polymer of glucose bearing one or more pendant alkenyl moieties can be made by reacting an oligomer or polymer of glucose, in which one or more of the hydroxyl groups have been converted to leaving groups, with a reactant bearing an alkenyl moiety and a nucleophilic group. For example, reaction of mono-6-deoxy-6-(p-tolylsulfonyl)-β-cyclodextrin with allylamine will produce mono-6-N-allylamino-6-deoxy-β-cyclodextrin.

Examples of leaving groups include, without limitation, a halide group, such as iodide, bromide or chloride, a mesylate, a tosylate, a triflate, or a haloformate ester group.

Preferably, only the hydroxyl groups at the 6-position of the glucose moieties are converted to leaving groups. Conversion of hydroxyl groups at the 2- and 3-positions, in addition to the 6-position, to leaving groups, is also, however, within the scope of the invention. Conversion of hydroxyl groups at the 2-, 3- or 6-positions may be partial or complete.

Examples of reagents that can be used to convert the hydroxyl groups of glucose to leaving groups include, without limitation SOCl₂, PBr₃, tosyl chloride, mesyl chloride, triflic anhydride, and esters of chloroformic acid.

As primary hydroxyl groups react more readily than secondary hydroxyl groups, it is possible to ensure that only the primary hydroxyl groups are converted to leaving groups by selection of the appropriate molar ratios of reagent to hydroxyl groups. Preferably only some of the primary hydroxyl groups of the glucose moieties of β-cyclodextrin are converted to leaving groups. More preferably, five, even more preferably six, and most preferably seven of the primary hydroxyl groups are converted to leaving groups.

The reactant bearing an alkenyl moiety and a nucelophilic group is preferably a straight-chained α-olefin with a nucleophilic group attached to the ω-carbon atom, such as, for example, a compound of formula (IV):

CH₂═CH(CH₂)ₙZ (IV)

wherein n is a number in the range of from 1 to 20, and Z is a nucleophilic group, for example, an amino group. The number of carbon atoms in the reactant is not critical, but is suitably in the range of from 3 to 20, and allylamine is mentioned as an example. One or more methylene groups in the reactant can be replaced by an oxygen atom, an NH group, an NR′ group, a sulfur atom or a SiR′₂ group, where R′ is defined above.

As an example, reaction of a compound of formula (IV), where Z is NH₂, with the glucose units of β-cyclodextrin some of whose primary hydroxyl groups have been converted to tosylate groups will result in the formation of a β-cyclodextrin having alkenyl moieties attached to the carbon atoms that previously bore tosylate groups. The attachment will be by imino linkages.

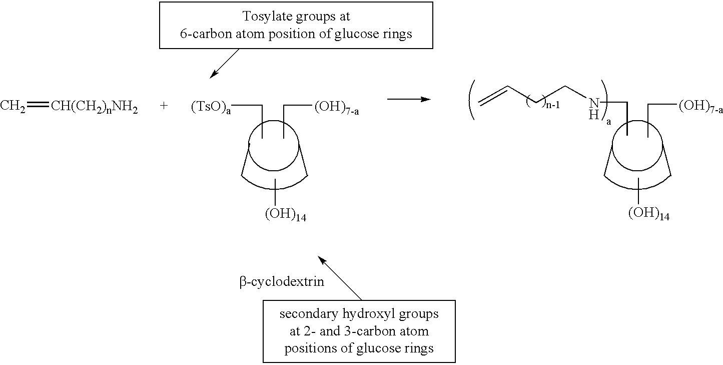

Any remaining hydroxyl groups at the 2-, 3- and 6-carbon atom positions of the glucose moieties of the oligomer or polymer of glucose bearing a pendant alkenyl moiety can be modified with protecting groups. Examples of suitable protecting groups are provided in “Protective Groups in Organic Chemistry”, by T. W. Greene and P. G. M. Wuts (John Wiley & Sons, 1999), which reference is incorporated herein by reference. It is preferred that any remaining hydroxyl groups at the 2-, 3- and 6-positions are fully functionalized.

The expression “fully-functionalized” as used herein indicates that all of the hydroxyl groups of the glucose units have been either protected with a protecting group or derivatized with a derivatizing agent. It is to be appreciated, however, that the functionalizing or derivatizing reaction may not go entirely to completion, so there may be one or more hydroxyl groups still present.

Any remaining hydroxyl groups of the oligomer or polymer of glucose which are not linked to the alkenyl moieties can be functionalized to form, for example, alkoxy groups, aryloxy groups, arylalkyloxy groups, ester groups, carbamate groups, carbonate groups, phosphinate groups, phosphonate groups, phosphate groups, sulfinate groups, sulfite groups, sulfonate groups or sulphate groups. The product of this functionalization step is an oligomer or polymer of glucose which bears one or more alkenyl moieties and which is fully functionalized.

If hydroxyl groups are to be converted to alkoxy groups, aryloxy groups or arylalkyloxy groups this can be done by alkylating them with a compound of formula (V):

R³Y (V)

where R³ is an alkyl, an aryl group or an arylalkyl group, and Y is a leaving group, for example, a halide such as iodide, bromide or chloride, or a tosylate, a mesylate or a triflate.

If hydroxyl groups are to be converted to ester groups or carbonate groups this can be done by acylating them with a compound of formula (VI):

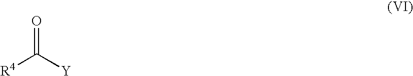

where R⁴ is an alkyl group, an aryl group, an arylalkyl group, an alkoxy group, an aryloxy group, or an arylalkyloxy group, and Y is defined above;

or by acylating them with a compound of formula (VII):

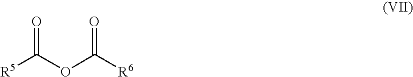

where R⁵ and R⁶ are independently an alkyl group, an aryl group, an arylalkyl group, an alkoxy group, an aryloxy group, or an arylalkyloxy group.

If hydroxyl groups are to be converted to carbamate groups this can be done by reacting them with a compound of formula (VIII):

R⁷—N═C═O (VIII)

where R⁷ is an alkyl group, an aryl group or an arylalkyl group.

If hydroxyl groups are to be converted to phosphinate groups, phosphonate groups, or phosphate groups, this can be done by reacting them with a compound of formula (IX):

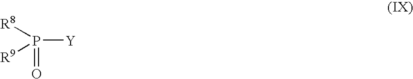

where R⁸ and R⁹ are, independently, hydrogen, an alkyl group, an aryl group, an arylalkyl group, an alkoxy group, an aryloxy group, or an arylalkyloxy group, and Y is defined above.

If hydroxyl groups are to be converted to sulfinate groups or sulfite groups this can be done by reacting them with a compound of formula (X):

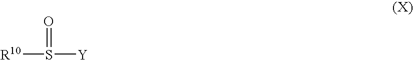

or they can be converted to sulfonate or sulfate groups by reacting them with a compound of formula (XI):

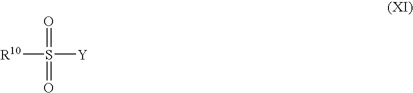

where R¹⁰ is an alkyl group, an aryl group, an arylalkyl group, an alkoxy group, an aryloxy group, or arylalkyloxy group, and Y is defined above.

As examples of alkyl groups that can be used as groups R′, R², R³, R⁴, R⁵, R⁶, R⁷, R⁸, R⁹ or R¹⁰ there are mentioned straight-chained and branched alkyl groups having up to 6 carbon atoms, especially methyl and ethyl, and cycloalkyl groups containing 5 or 6 carbon atoms. As examples of aryl groups there are mentioned phenyl and α- and β-naphthyl groups. As an example of an arylalkyl group there is mentioned a benzyl group.

Any remaining hydroxyl groups that are to be functionalized are preferably functionalized using a large molar excess of functionalizing agent in order to promote full functionalization. Preferably, the excess is in the range of from about 10:1 to about 50:1, more preferably from about 20:1 to about 40:1.

The pendant alkenyl moieties of the oligomer or polymer of glucose, which bears one or more alkenyl moieties and which is fully functionalized, is preferably hydrosilylated by reaction with a hydrosilylating agent to produce a hydrosilylated product that bears silyl moieties that comprise groups of formula (XII):

—SiR¹¹R¹²R¹³ (XII)

wherein each of R¹¹, R¹² and R¹³ is an alkyl group or alkoxy group of up to 6 carbon atoms, an aryl group, an arylalkyl group, an aryloxy group, or an arylalkyloxy group, wherein the aryl moiety is a phenyl or α- or β-naphthyl group or a halogen atom (fluorine, chlorine, bromine or iodine), provided that at least one of R¹¹, R¹² and R¹³ is a readily hydrolysable group such as an alkoxy or aryloxy group or a halogen atom.

The hydrosilylating agent is preferably a compound of formula (XIII):

HSiR¹¹R¹²R¹³ (XIII)

where R¹¹, R¹² and R¹³ are as defined above. The hydrosilylating agent adds to the double bond of the pendant alkenyl moiety. As an example, reaction of a hydrosilylating agent of formula (XIII) with an alkenyl moiety of formula (II) results in a hydrosilylated group of formula (XIV)

R¹³R¹²R¹¹SiCH₂CH₂(CH₂)ₙ— (XIV)

where R¹¹, R¹², R¹³ and n are as defined above.

The hydrosilylation reaction can be catalysed. Suitable catalysts include tetrakis(triphenylphosphine) platinum(0), [PtCl₂(cyclohexene)]₂, PtCl₂(1,5-cyclooctadiene), trans-PtCl₂(SEt₂)₂, and H₂PtCl₆.

The hydrosilylated product, that is, the oligomer or polymer of glucose bearing a silyl moiety, can then be reacted with a support material bearing free hydroxyl groups to form a conjugate of the invention.

The support material can be an inorganic material, for example silica gel, Al₂O₃, TiO₂ or ZrO₂, or a synthetic polymer material, all of which bear free hydroxyl groups. For example, if the support material is silica gel, and the hydrolysable group on the hydrosilylated product is an alkoxy group there will be formed an Si—O—Si linkage to link the oligomer or polymer of glucose to the support material, with elimination of an alkanol.

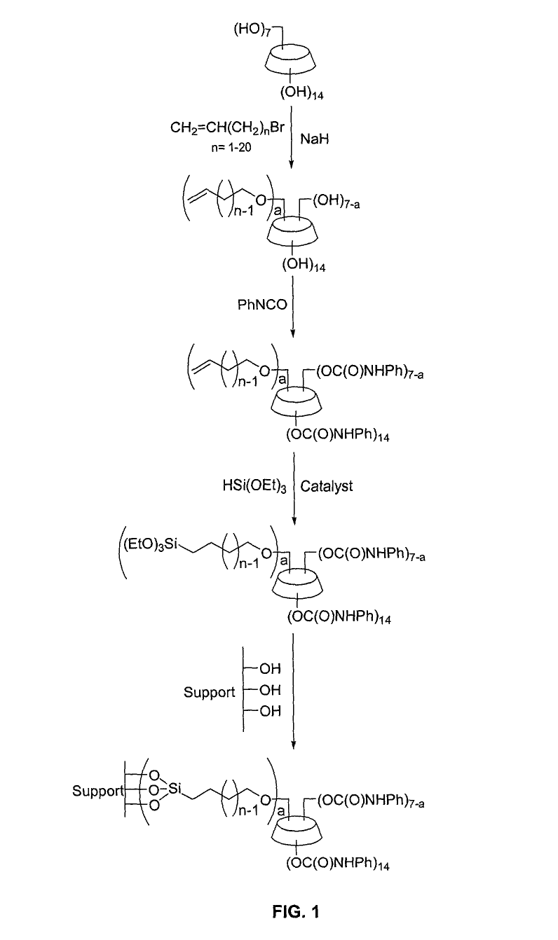

FIG. 1 shows an embodiment of the process of this invention, in which β-cyclodextrin bearing pendant silyl groups is reacted with a silica gel support.

The pendant alkenyl moieties of the oligomer or polymer of glucose, which is fully functionalized, can be converted to reactive groups other than silyl groups by, for example, addition reactions. In one embodiment, the pendant alkenyl moieties can be converted to electrophilic moieties that are reactive with groups on the support material. These electrophilic moieties are preferably of the formula (XV):

YCH₂CH₂(CH₂)ₙ— (XV)

where Y is iodide, bromide, chloride, a tosylate, a mesylate, or a triflate, and n is a number in the range of from 1 to 20.

For example, the pendant alkenyl moieties can be converted to alkyl halide groups through a radical-mediated halogenation reaction (e.g., a reaction using HBr in the presence of peroxides), and the resulting product then reacted with a support bearing thiol groups (e.g. silica gel immobilized with alkyl thiol groups) to form thio-ether (sulfide) linkages.

In alternative embodiments, the pendant alkenyl moieties can be converted to nucleophilic groups that are reactive with groups on the support material. For example, pendant alkenyl moieties can be photochemically reacted with thioacetic acid, to produce thioacetylated moieties, which can be converted to thiols by reaction with NH₂NH₂ in the presence of methanol. The thiol groups are preferably of the formula (XVI):

HSCH₂CH₂(CH₂)ₙ— (XVI)

where n is a number in the range of from 1 to 20.

The photochemical reaction is suitably conducted in the presence of a radical initiator, such as azobisisobutyronitrile (AIBN). A conjugate of the oligomer or polymer of glucose with a support material can then be formed, for example, by reacting the thiol groups with a support bearing alkyl halide groups (e.g. silica gel immobilized with alkyl halide groups) to form thio-ether (sulfide) linkages.

The thio-ether (sulfide) linkages formed between the support material and the oligomer or polymer of glucose may be further oxidized to sulfoxide or sulfonate groups. Examples of oxidizing agents that can be used to oxidize the sulfide include H₂O₂ or NaIO₄.

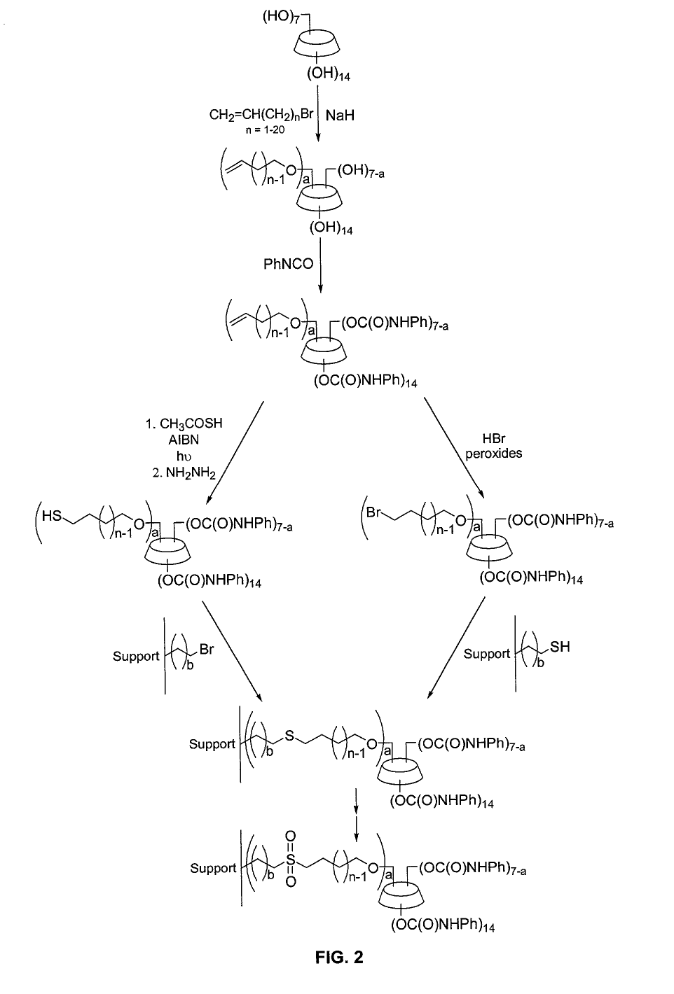

FIG. 2 shows embodiments of the process of this invention, in which β-cyclodextrin bearing pendant thiol groups or alkyl bromide groups is reacted with a support.

After the glucose moieties have been bound to the support material it is possible to treat the support material in an “end-capping” reaction in which reactive sites on the support material are protected. For instance, surface hydroxyl groups on silica gel, or silica gel immobilized with reactive groups, such as alkyl thiol groups or alkyl halide groups, can be reacted with a reactive silane such as, for example, trimethylchlorosilane or hexamethyldisilazane to block the surface hydroxyl groups.

The conjugate of the invention is particularly suitable for use in chromatography, for example high performance liquid chromatography (HPLC), liquid chromatography (LC), thin layer chromatography (TLC), capillary electro-chromatography (CEC) and counter-current chromatography. The conjugates are particularly valuable as a chiral stationary phase (CSP) for resolving enantiomeric mixtures and in determining enantiomeric purity. The conjugates of the invention permit good reproducibility of separation, even after long run times in reverse phase separations using mobile phases having a high aqueous concentration. Their utility extends beyond use in chromatography, however. They can also be used for example in electrophoresis.

For use in chromatography it is preferred that the support material is in the form of spherical particles whose size is preferably from about 1 μm to about 50 μm, more preferably about 2 μm to 10 μm. For use in HPLC analytical separation a particle size of about 5 μm is preferred.

The invention is further illustrated by the following non-limiting examples:

### EXAMPLE 1

mono-6-N-Allylamino-6-deoxy-β-cyclodextrin (1)

A solution of mono-6-deoxy-6-(p-tolylsulfonyl)-β-cyclodextrin (2.23 g) in allylamine (30 ml) was refluxed for 5 hours, the resultant solution was cooled to room temperature (25° C.) and diluted with methanol (30 ml). After addition of acetonitrile (200 ml) with stirring, a white product (1) was precipitated, filtered and dried under high vacuum (1.65 g, 82%): m.p.: 195° C. (dec.); [α]_{D} +122° (c 0.93, water); ¹³C-NMR(300 MHz, DMSO-d₆) d: 51.47(CH₂NH), 59.84(C-6), 71.93(C-2), 72.31(C-5), 72.95(C-3), 81.39˜81.46(C-4), 101.73˜101.87(C-1), 115.23(CH═CH₂), 137.23(CH═CH₂).

### EXAMPLE 2

Partial-6-(5-pent-1-enylated)-β-cyclodextrin (2)

β-cyclodextrin having some of the hydroxyl groups at the 6-position of its glucose moieties functionalized with 5-pent-1-enyl groups, was prepared according to the procedure previously reported by Tanaka et al. (Anal. Chem., 1995, Vol. 11, 227-231).

β-cyclodextrin (8.94 g, 7.87 mmol) was dissolved in 400 mL of DMF before bromo-1-pentene (1.76 g, 11.81 mmol) and sodium hydride (0.19 g, 7.88 mmol) were added. This mixture was stirred at room temperature for 24 hours, after which the DMF was removed under vacuum, and the residue was recrystallized four times from water. Partial-6-(5-pent-1-enylated)-β-cyclodextrin (2) was obtained as a white solid in 17% yield.

### EXAMPLE 3

Partial-6-(5-pent-1-enylated)-perphenylcar-bamoylated β-cyclodextrin (3)

Partial-6-(5-pent-1-enylated)-β-cyclodextrin, 2 (2.00 g, 1.76 mmol from Example 2) was dissolved in dry pyridine (ca. 60 mL) before phenyl isocyanate (10 mL) was added. The mixture was stirred for 15 hours at 95° C. The resultant reaction mixture was then filtered and the filtrate was evaporated. The residue was dissolved in diethyl ether (100 mL and washed with water (100 mL×3). After drying over anhydrous magnesium sulfate, the solvent was removed and the residue was subjected to flash chromatography over silica gel using hexane-chloroform (1:4) as eluant to provide partial-6-(5-pent-1-enylated)-perphenylcarbamoylated β-cyclodextrin (3) in 70% yield. mp: 198-200° C.; [α]_{D} =+8.5° (c 1.0, CHCl₃); IR (cm⁻¹): 3401, 3315 (N—H str); 3145, 3059 (arom C═C ring str); 2930, 2862 (C—H str); 1733 (C═O, str); 1598, 1533, 1447 (arom C═C ring str); 1227, 1049 (C—O—C str); 749 (C—H arom op bend); ¹H NMR (CDCl₃) δ (ppm): 7.38-6.56 (m, 120 H), 5.90-5.80 (m, 1H), 5.56-3.60 (m, 55H), 1.30-1.20 (m, 16 H); ¹³C-NMR (CDCl₃, 25° C.) δ (ppm): 153.7-152.7, 137.0-136.8, 128.7-128.4, 123.6, 119.7-118.8, 114.0, 98.8, 78.8, 73.5, 69.7, 67.8, 62.0, 60.3, 33.7-20.9; Microanalysis for C₁₉₄H₁₉₂N₂₂O₅₅ (3711.77); calculated C 62.78%, H 5.21%, N 8.31%; found C 61.94% H 5.38%, N 7.89%.

### EXAMPLE 4

Partial-6-(5-pent-1-enylated)-pernaphthylcar-bamoylated β-cyclodextrin (4)

Partial-6-(5-pent-1-enylated)-β-cyclodextrin, 2 (2.00 g, 1.76 mmol, from Example 2) was dissolved in dry pyridine (ca. 60 mL) before 2-naphthyl isocyanate (10 mL) was added. The mixture was stirred for 15 hours at 95° C. The resultant reaction mixture was then filtered and the filtrate was evaporated. The residue was dissolved in diethyl ether (100 mL) and washed with water (100 mL×3). After drying over anhydrous magnesium sulfate, the solvent was removed and the residue was subjected to flash chromatography over silica gel using hexane-chloroform (1:4) as eluant to provide partial-6-(5-pent-1-enylated)-pernaphthylcarbamoylated β-cyclodextrin (4) in 70% yield. mp: 115-117° C.; [α]_{D} +106.1° (c 1.0, CHCl₃); IR (cm⁻¹): 3427 (N—H str), 2937, 2859 (C—H str), 1744, 1663 (C═O str), 1227, 1042 (C—O—C str); ¹H-NMR (CDCl₃, TMS) δ (ppm): 5.85-5.76 (m, 1H, C═CHR), 5.38-5.21 (m, 7H, (H3)), 5.16-5.05 (m, 7H, (H1)), 5.02-4.94 (m, 4H, (C═CH₂ and NH)), 4.84-4.68 (m, 7H, (H2)), 4.58-4.50 (d, 6H, J=12 Hz, (Hb6)), 4.35-4.26 (d, 6H, J=12.7 Hz, (Hb6′)), 4.24-4.05 (m, 7H, (Ha5)), 3.78-3.64 (m, 7H, (H4)), 3.57-3.51 (m, 1H, (Ha6)), 3.49-3.35 (m, 1H, (Ha6′)), 3.30-3.18 (m, 1H, NCH₂R), 3.11-3.00 (m, 1H, NCH₂′R), 2.18-2.00 (several s, 60 H, CH₃CO), 1.46-1.19 (m, 16 H, (CH₂)8); ¹³C-NMR (CDCl₃, 25° C.) δ (ppm): 170.6-169.3 (CH₃CO), 158.0 (NH—CO—NH), 139.1 (CH₂═CR), 113.9 (CH₂═CR), 96.6-96.4 (C1), 77.4-76.5 (C4), 70.7-69.5 (C2, C3, C4), 62.4 (Cb6), 41.2 (Ca6), 40.3 (NHCH₂R), 33.7-26.8 ((CH₂)₈), 20.62 (CH₃CO); Microanalysis for C₉₄H₁₃₂N₂O₅₅: Calculated C 52.01%, H 6.13%, N 1.29%; Found C 51.72%, H 6.30%, N 1.20%.

### EXAMPLE 5

Partial-6-(5-pent-1-enylated)-peracetylated-β-cyclodextrin (5) was prepared in 90% yield by stirring partial-6-(5-pent-1-enylated)-β-cyclodextrin (2 from Example 2) with acetic anhydride/pyridine at 40° C.

### EXAMPLE 6

Partial-6-(5-pent-1-enylated)-permethylated-β-cyclodextrin (6) was prepared in 70% yield by reaction of partial-6-(5-pent-1-enylated)-β-cyclodextrin (2 from Example 2) in CH₃I/DMF/NaH at 40° C.

### EXAMPLE 7

Partial-6-(5-pent-1-enylated)-perphenylcarbamoylated β-cyclodextrin, 3 (1.5 g, from Example 3), triethoxysilane (ca. 10 mL) and tetrakis(triphenylphosphine) platinum(0) (20 mg) were mixed together in a 50 mL round bottom flask. After stirring for 72 hours, the mixture was poured into a Buchner funnel packed with a 2 cm layer of silica gel and was eluted with 100 mL of diethyl ether. After the removal of volatile components (by-products, solvent, and/or unreacted triethoxysilane) at 100° C./0.5 mm Hg, 1.6 g of a yellow viscous oil was obtained. The viscous oil was dissolved in dried toluene (50 mL) and then 3.5 g of silica gel (dried over 180° C./0.5 mm Hg for 5 hours was added. The mixture was refluxed with stirring for about 10 hours. After 1 mL of water was added, the mixture was stirred for another 5 hours. The resultant reaction mixture was filtered, and the silica gel remaining was heated under N₂ gas for 4 hours at 160° C. before it was transferred to a soxhlet extraction apparatus and extracted with acetone for 24 hours. The perphenylcarbamoylated β-cyclodextrin (PPHCD) immobilized silica gel (7) was obtained after the removal of the acetone under vacuum. Elemental analysis C % 7.60, H % 0.94, N % 0.80.

### EXAMPLE 8

Partial-6-(5-pent-1-enylated)-pernaphthyl-carbamoylated, 4 (1.5 g, from Example 4), triethoxysilane (ca. 10 mL) and tetrakis(triphenylphosphine) platinum(0) (20 mg) were mixed together in a 50 mL round bottom flask. After stirring for 72 hours, the mixture was poured into a Buchner funnel packed with a 2 cm layer of silica gel and was eluted with 100 mL of diethyl ether. After the removal of volatile components (by-products, solvent, and/or unreacted triethoxysilane) at 100° C./0.5 mm Hg, 1.6 g of a yellow viscous oil was obtained. The viscous oil was dissolved in dried toluene (50 mL) and then 3.5 g of silica gel (dried over 180° C./0.5 mm Hg for 5 hours was added. The mixture was refluxed with stirring for about 10 hours. After 1 mL of water was added, the mixture was stirred for another 5 hours. The resultant reaction mixture was filtered, and the silica gel remaining was heated under N₂ gas for 4 hours at 160° C. before it was transferred to a soxhlet extraction apparatus and extracted with acetone for 24 hours. The pernaphthylcarbamoylated β-cyclodextrin (PNACD) immobilized silica gel (8) was obtained after the removal of the acetone under vacuum. Elemental analysis C % 8.13, H % 0.95, N % 0.81

### EXAMPLE 9

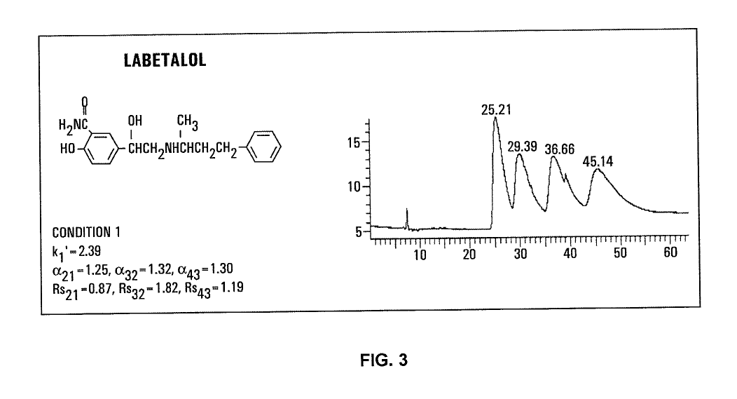

PPHCD (7) from Example 7 or PNACD (8) from Example 8 was packed into an empty column (250×4.6 mm). Good chiral separation could be achieved both in the normal phase and reverse phase. A wide variety of chiral compounds and pharmaceutical active ingredients could be easily separated using this column, and some results are given in Table 1. Peaks were detected by UV absorbance at 254 nm. FIG. 3 shows the separation of labetalol by HPLC using a PNACD immobilized silica column.

TABLE 1
Resolution of the Enantiomers of Chiral Drugs by
Reverse-Phase HPLC Using PPHCD- and PNACD Immobilized Silica Columns.

| | HPLC | | | | |
|---|---|---|---|---|---|
| Compound | Conditions | Column | k′ | α | Rs |
| Propranolol | Condition 1 | PNACD | 1.29 (R) | 1.50 | 1.53 |
| 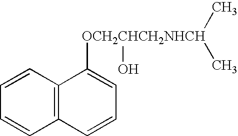 | Condition 2 | PPHCD | 1.38 (S) | 1.71 | 3.65 |
| O-acetyl Propranolol | Condition 3 | PNACD | 3.86 (R) | 1.21 | 1.66 |
| 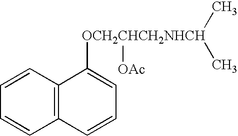 | Condition 2 | PPHCD | 1.71 (S) | 1.49 | 4.00 |
| Pindolol | Condition 3 | PNACD | 0.63 (R) | 1.29 | 0.90 |
| 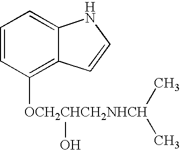 | Condition 2 | PPHCD | 0.47 (S) | 1.15 | 1.10 |
| Alprenolol | Condition 3 | PNACD | 1.61 (R) | 1.37 | 1.27 |
| 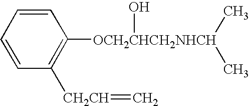 | Condition 2 | PPHCD | 0.84 (S) | 1.53 | 3.65 |
| Metoprolol | Condition 3 | PNACD | 1.12 (R) | 1.37 | 1.10 |
| 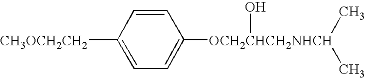 | Condition 4 | PPHCD | 1.00 (S) | 1.16 | 0.60 |
| (±)-Isoproterenol | Condition 3 | PNACD | 0.15 (R) | 4.73 | 1.27 |
| 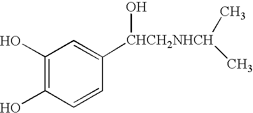 | Condition 4 | PPHCD | 0.10 (S) | 3.96 | 3.25 |
| Atropine | Condition 3 | PNACD | 0.99 | 1.36 | 1.13 |
| 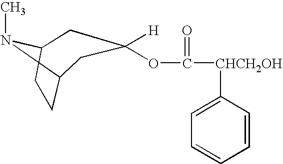 | Condition 2 | PPHCD | 0.65 | 4.38 | 5.24 |

Condition 1: MeOH/1% TEAA (pH 5.01) = 50/50 (v/v)
Condition 2: MeOH/1% TEAA (pH 4.65) = 40/60 (v/v)
Condition 3: MeOH/1% TEAA (pH 5.01) = 40/60 (v/v)
Condition 4: MeOH/1% TEAA (pH 4.65) = 35/65 (v/v)
Detection wavelength: 254 nm

Having now described the invention, it is not intended that it be limited except as may be required by the appended claims.

1. A conjugate comprising a support material and an oligomer or polymer of a saccharide, wherein the oligomer or polymer is linked to said support material via one or more ether, carbamate, ester, or imino linkages between the saccharide and the support material, and wherein the saccharide is fully functionalized.

2. The conjugate of claim 1, wherein the oligomer or polymer is linked to said support material via one or more ether linkages.

3. The conjugate of claim 1, wherein the oligomer or polymer is linked to said support material via one or more imino linkages.

4. The conjugate of claim 1, wherein the support material and the oligomer or polymer of a saccharide are linked by one or more linkers which comprise a group of the formula (I):
ACH₂CH₂(CH₂)ₙ₋₁CH₂B— (I)
between the saccharide and the support material, the group A being attached to the support material, and the group B being attached to the saccharide;
wherein A=—S, —S(O), —S(O)₂ or 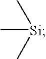
B is O, NH, a carbamate group, or an ester group, and
n is a number in the range of from 1 to 20.

5. The conjugate of claim 1, wherein the saccharide is glucose.

6. The conjugate of claim 5, wherein the oligomer or polymer of glucose is cellulose.

7. The conjugate of claim 5, wherein the oligomer or polymer of glucose is amylose.

8. The conjugate of claim 5, wherein the oligomer or polymer of glucose is a cyclodextrin.

9. The conjugate of claim 5, wherein the oligomer or polymer of glucose is β-cyclodextrin.

10. The conjugate of claim 5, wherein the linkage is to the 6-carbon atom of the glucose moiety.

11. The conjugate of claim 1, wherein the hydroxyl groups of the saccharide, which are not linked to the support material, are functionalized to form alkoxy groups, aryloxy groups, arylalkyloxy groups, ester groups, carbamate groups, carbonate groups, phosphinate groups, phosphonate groups, phosphate groups, sulfinate groups, sulfite groups, sulfonate groups or sulphate groups.

12. The conjugate of claim 1, wherein the support material is selected from the group consisting of silica gel, Al₂O₃, TiO₂, ZrO₂ and, synthetic porous functional organic polymers.

13. The conjugate of claim 1, wherein the support material is silica gel.

14. A process for preparing a conjugate of a support material and an oligomer or polymer of a saccharide, the process comprising reacting the support material with an oligomer or polymer of a saccharide reactant bearing one or more pendant electrophilic moieties or nucleophilic moieties, wherein the electrophilic moieties or nucleophilic moieties are linked to said saccharide via one or more ether, carbamate, ester, or imino linkages, and the support material has groups that are reactive with said electrophilic moieties or said nucleophilic moieties, and wherein the saccharide reactant is fully functionalized.

15. The process of claim 14, wherein the electrophilic moieties are silyl moieties having at least one readily hydrolysable group attached to the silicon atom.

16. The process of claim 15, wherein the silyl moieties comprise groups of formula (XII):
—SiR¹¹R¹²R¹³ (XII)
wherein each of R¹¹, R¹² and R¹³ is an alkyl group or an alkoxy group of up to 6 carbon atoms, an aryl or aryloxy wherein the aryl moiety is a phenyl or α- or β-naphthyloxy group or a halogen atom provided that at least one of R¹¹, R¹² and R¹³ is a readily hydrolysable group.

17. The process of claim 15, wherein the silyl moieties are groups of the formula (XIV):
R¹³R¹²R¹¹SiCH₂CH₂(CH₂)ₙ— (XIV)
wherein each of R¹¹, R¹² and R¹³ is an alkyl group or an alkoxy group of up to 6 carbon atoms, an aryl or aryloxy wherein the aryl moiety is a phenyl or α- or β-naphthyloxy group or a halogen atom provided that at least one of R¹¹, R¹² and R¹³ is a readily hydrolysable group, and n is a number in the range of from 1 to 20.

18. The process of claim 15, wherein the oligomer or polymer of a saccharide bearing one or more pendant silyl moieties is formed by reacting an oligomer or polymer of a saccharide bearing one or more pendant alkenyl moieties with a hydrosilylating agent.

19. The process of claim 18, wherein said one or more pendant alkenyl moieties are of the formula (II):
CH₂═CH(CH₂)ₙ— (II)
wherein n is a number in the range of from 1 to 20.

20. The process of claim 18, wherein the hydrosilylating agent is a compound of formula (XIII):
HSiR¹¹R¹²R¹³ (XIII)
wherein each of R¹¹, R¹² and R¹³ is an alkyl group or an alkoxy group of up to 6 carbon atoms, an aryl or aryloxy wherein the aryl moiety is a phenyl or α- or β-naphthyloxy group or a halogen atom provided that at least one of R¹¹, R¹² and R¹³ is a readily hydrolysable group.

21. The process of claim 14, wherein the support material is silica gel.

22. The process of claim 14, wherein the electrophilic moieties are groups of the formula (XV):
YCH₂CH₂(CH₂)ₙ— (XV)
where Y is iodide, bromide, chloride, a tosylate group, a mesylate group, or a triflate group, and n is a number in the range of from 1 to 20.

23. The process of claim 22, wherein the support material is a silica gel immobilized with thiol groups, and the reaction of said electrophilic moieties with said thiol groups forms a thio-ether linkage.

24. The process of claim 23, further comprising a step of oxidizing the thio-ether linkage to a sulfoxide or a sulfone.

25. The process of claim 14, wherein the nucleophilic moieties are thiol groups.

26. The process of claim 14, wherein the nucleophilic moieties are thiol groups are of the formula (XVI):
HSCH₂CH₂(CH₂)ₙ— (XVI)
where n is a number in the range of from 1 to 20.

27. The process of claim 25, wherein the support material is a silica gel immobilized with electrophilic groups, and the reaction of said electrophilic moieties with said thiol groups forms a thio-ether linkage.

28. The process of claim 27, further comprising a step of oxidizing the thio-ether linkage to a sulfoxide or a sulfone.

29. The process of claim 14, wherein the saccharide is glucose.

30. The process of claim 29, wherein the oligomer of polymer of glucose is cellulose.

31. The process of claim 29, wherein the oligomer of polymer of glucose is amylose.

32. The process of claim 29, wherein the oligomer of polymer of glucose is a cyclodextrin.

33. The process of claim 29, wherein the oligomer of polymer of glucose is β-cyclodextrin.

34. The process of claim 18, wherein said oligomer or polymer of glucose bearing one or more pendant alkenyl moieties is fully functionalized by converting all free hydroxyl groups to groups selected from the group consisting of alkoxy groups, aryloxy groups, arylalkyloxy groups, ester groups, carbamate groups, carbonate groups, phosphinate groups, phosphonate groups, phosphate groups, sulfinate groups, sulfite groups, sulfonate groups and sulphate groups.

35. An oligomer or polymer of a saccharide bearing one or more pendant electrophilic moieties or nucleophilic moieties, wherein the electrophilic moieties or nucleophilic moieties are linked to said saccharide via one or more ether, carbamate, ester, or imino linkages, and wherein the saccharide is fully functionalized.

36. The oligomer or polymer of claim 35, wherein the electrophilic moieties are silyl moieties having at least one readily hydrolysable group attached to the silicon atom.

37. The oligomer or polymer of claim 35, wherein the silyl moieties are groups of the formula (XIV):
R¹³R¹²R¹¹SiCH₂CH₂(CH₂)ₙ— (XIV)
wherein each of R¹¹, R¹² and R¹³ is an alkyl group or an alkoxy group of up to 6 carbon atoms, an aryl or aryloxy wherein the aryl moiety is a phenyl or α- or β-naphthyloxy group or a halogen atom provided that at least one of R¹¹, R¹² and R¹³ is a readily hydrolysable group, and n is a number in the range of from 1 to 20.

38. The oligomer or polymer of claim 35, wherein the electrophilic moieties are groups of the formula (XV):
YCH₂CH₂(CH₂)ₙ— (XV)
where Y is iodide, bromide, chloride, a tosylate, a mesylate, or a triflate, and n is a number in the range of from 1 to 20.

39. The oligomer or polymer of claim 35, wherein the nucleophilic moieties are thiol groups.

40. The oligomer or polymer of claim 39, wherein the thiol groups are of the formula (XVI):
SHCH₂CH₂(CH₂)ₙ— (XVI)
and n is a number in the range of from 1 to 20.

41. A chromatographic process comprising separating compounds using, as a stationary phase, a conjugate which comprises a support material linked to oligomers or polymers of a saccharide, which linking is via one or more ether, carbamate, ester, or imino linkages between the saccharide moieties and the support material, and wherein the saccharide moieties are fully functionalized.

42. The chromatographic process of claim 41, wherein the conjugate is used as a chiral stationary phase in enantiomeric separation or enantiomeric analysis.
